(19) United States
(12) Patent Application Publication
(10) Pub. No.: US 2007/0050316 A1
(43) Pub. Date: Mar. 1, 2007

(54) System for automated package mailing

(76) Inventor: Lutrell Denson, Philadelphia, PA (US)

Correspondence Address: Licata & Tyrrell P.C., 66 East Main Street, Marlton, NJ, 08053, US

(21) Appl. No.: 11/369,680

(22) Filed: Mar. 7, 2006

Related U.S. Application Data
(60) Provisional application No. 60/659,147, filed on Mar. 7, 2005.

(51) Int. Cl. G01G 19/413

(52) U.S. Cl. 705/407; 177/25.15

(57) ABSTRACT

A walk up or drive through package mailing system is provided.

This patent application claims the benefit of priority from U.S. Provisional Application Ser. No. 60/659,147, filed Mar. 7, 2005 teachings of which are herein incorporated by reference in their entirety.

### BACKGROUND OF THE INVENTION

Presently, to mail a package a customer must assemble the items to be shipped, wrap the box, and address the package properly. Then, the dreaded part, the customer has to get to the post office before it closes with the package. They must then lift the package out of the car, carry the package into the post office, and stand in line kicking the package forward until they reach the desk. Then, the customer must lift the package up onto the counter to be weighed. This is enough to make anyone procrastinate mailing their packages.

### BRIEF DESCRIPTION OF THE FIGURES

FIG. 1 provides a diagram of an embodiment of a package mailing system of the present invention.

FIG. 2 provides a diagram of an embodiment of a package mailing system of the present invention positioned for drive through or walk-up customer use.

### DETAILED DESCRIPTION OF THE INVENTION

The present invention provides a system which makes a customer's package mailing painless, quick and effortless.

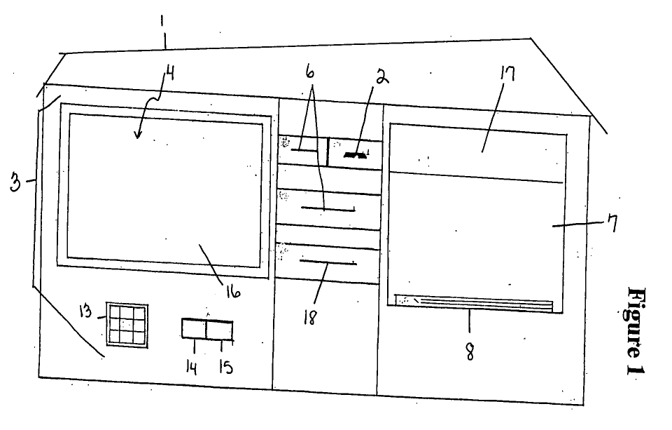

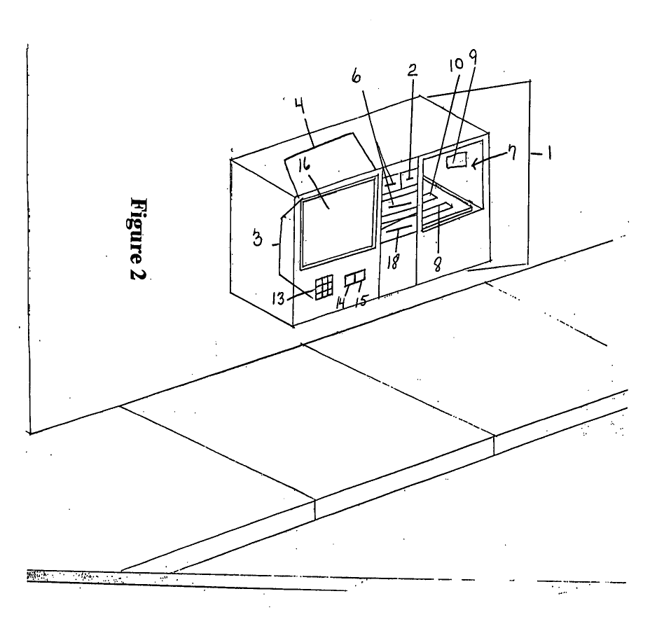

In simplest form, the package mailing system 1 comprises a payment insertion means 2, a data entry means 3, a data display means 4, a printer 5, a dispenser for printed receipts and/or package mailing labels 6, and a receptacle for packages 7, said receptacle 7 being equipped with a scale 8, a scanner 9 and a conveyor belt 10. See FIGS. 1 and 2.

The payment insertion means 2 comprises an insertion slot 11 designed to accept credit cards, bank cards, prepaid package mailing system cards and/or cash.

In a preferred embodiment, the payment insertion means 2 accepts prepaid package mailing system cards. Such prepaid cards can be designed to include a personal identification means such as a photograph or personal identification number (PIN) and may be purchased directly from the post office or other package mailing company. For security, the photograph on the prepaid card or PIN associated with the card identifies the sender as the customer who purchased the card. As will be understood by the skilled artisan upon reading this disclosure, other means for personal identification including, but not limited to fingerprints or retinal scans can also be used. The package mailing system is preferably equipped with a means for customers to add additional funds to their prepaid card by cash, credit card or bank card. Additional funds could also be added to the card at the post office or other package mailing company by cash, check, credit card or bank card.

Embodiments wherein the package mailing system accepts cash, credit cards or bank cards for payment are also included within the scope of the invention.

The payment insertion means 12 of the package mailing system 1 of the present invention further comprises a card scanner 12 behind the slot 11 which accepts this prepaid card or a credit card or bank card and when necessary, as in the case of a prepaid card, identifies the customer.

The package mailing system 1 of the present invention also comprises a data entry means 3 for entry of data by the customer and a data display means 4 for prompting the customer to enter the required data and display of entered data. As shown in FIG. 1, the data entry means 3 preferably comprises a key pad 13, an enter transaction button 14, a cancel transaction button 15 and a touch screen 16, which also serves as the data display means 4. However, as will be understood by those skilled in the art, other data entry and display means can be used.

In a preferred embodiment, the package mailing system 1 is equipped with automated voice assistance similar to self check out at the supermarket to assist the customer with required data entry.

The package mailing system 1 further comprises a printer 5 for printing package mailing labels and receipts and a dispenser 6 for providing the printed receipts and/or package mailing labels to be placed upon the package to the customer. As shown in FIGS. 1 and 2, separate dispensers may be provided for the package mailing label and the receipt.

The package mailing system 1 further comprises a package receptacle 7 into which the package is placed. The package receptacle 7 is equipped with a scale 8, a package mailing label scanner 9, and a conveyor belt 10. In a preferred embodiment, the receptacle further comprises a door 17 which remains closed until the transaction by the customer begins and closes once the transaction is complete.

In the embodiment depicted in FIG. 1, the scale 8 is located inside the package receptacle 7. However, as will be understood by the skilled artisan upon reading this disclosure, alternative arrangements wherein the scale 8 is located outside the package receptacle can also be used.

As shown in FIG. 2, the components of the package mailing system 1 are preferably arranged so that the customer can drive through or walk up to the package mailing system and conveniently weigh and pay for mailing of their packages.

To use the package mailing system of the present invention, the customer drives or walks up to the package mailing system 1 and places their package on the scale 8 in the package receptacle 7. In embodiments with a door 17, the package mailing system 1 may first require activation via, for example, insertion of a payment means or touching of the touch screen 16 to open the door 17 of the package receptacle 7. The customer activates the voice assistance, if the package mailing system is so equipped and/or the data display means 4 which prompts the customer for data entry by scanning their prepaid card, credit card or bank card. The voice assistance and/or data display means 4 guides the customer through the process. The customer enters all required information (i.e., name of recipient, address, zip code, etc.) into the package mailing system 1 via the data entry means 3. In one embodiment, the customer may enter the weight of the package from an output display the scale 8. Alternatively, the scale may be connected directly to the data entry means 3 and be included with the package information without entry by the customer. The printer 5 of the package mailing system 1 then prints and dispenses a label to be adhered to the package with all the information necessary to mail the package (referred to herein as a package mailing label or a trip ticket). The customer then places the trip ticket on the package and completes the transaction as instructed by placing the package back in the package receptacle 7 and hitting enter. Once the customer hits enter, thereby completing the transaction, in embodiments with a door 17, the door 17 of the package receptacle preferably closes. In a preferred embodiment, the only way to re-open package the package receptacle is to begin another transaction. The package is then automatically scanned for the trip ticket. Its weight is also re-measured to make sure the same package was placed in the package receptacle. The package is then automatically sent on a conveyor belt 10 that takes the package to a large bin in the post office of other package mailing company for further distribution. These drive through/walk up package mailing systems can be placed at the post office or package mailing company as well as at grocery stores, drug stores, office building lobbies and/or other secure businesses that are open 24 hours for more convenience. Post office employees or employees of the package mailing companies can retrieve these packages daily and transport them where required for mailing.

The package mailing system of the present invention allows a customer to mail packages day or night regardless of whether the post office or other package mailing business is open or closed.

The package mailing system can also be designed to dispense stamps 18.

What is claimed is:

1. A package mailing system comprising a payment insertion means, a data entry means, a data display means, a printer, a dispenser for printed receipts and/or package mailing labels, and a receptacle for packages, said receptacle being equipped with a scale, a scanner and a conveyor belt.

2. The package mailing system of claim 1 further comprising a stamp dispenser.

3. The package mailing system of claim 1 further comprising a door on the package receptacle.
